(19) United States
(12) Patent Application Publication
(10) Pub. No.: US 2009/0055804 A1
(43) Pub. Date: Feb. 26, 2009

(54) Method and device for automatically evaluating the quality of a software source code

(76) Inventors: Gunther Blaschek, Linz (AU); Christian Komer Komer, Bergen (AU); Reinhold Plosch, Linz (AU); Gustav Pombergen, Linz (AU); Stefan Schiffer, Vorchdort (AU); Stephan Storch, Princeton, NJ (US)

Correspondence Address: HARNESS, DICKEY & PIERCE, P.L.C., P.O.BOX 8910, RESTON, VA, 20195, US

(21) Appl. No.: 11/991,429

(22) PCT Filed: Jul. 31, 2006
(86) PCT No.: PCT/EP2006/064844

§ 371 Date: Mar. 4, 2008

(30) Foreign Application Priority Data
Sep. 5, 2005 (DE) 102005 042 126.1

(51) Int. Cl. G06F 9/44

(52) U.S. Cl. 717/126

(57) ABSTRACT

A method and device are disclosed for automatically evaluating a software source code quality, wherein evaluation rules and/or metrics for evaluating the software source code are pre-set. The source code is inspected with the aid of a set of evaluation rules and/or metrics, wherein the set contains at least one part of pre-set evaluation rules and/or metrics. In addition, in at lest one embodiment, the set of evaluation rules and/or metrics used for inspecting the source code is adapted according to the evaluation of a performed inspection of the source code with respect to at lest one predefined criterion for forming an adapted set of evaluation rules and/or metrics different from the first set. In addition, the source code is inspected by way of the adapted set of evaluation rules and/or metrics. At lest one embodiment of the invention makes it possible to evaluate advantageously and automatically a large number of source codes with respect to the quality and the improvement thereof and to adapt the set of evaluation rules and/or metrics and, thereby the quality inspection to specific requirements, for example, related to projects. At least one embodiment of the invention makes it possible to carry out a modern control of the internal software quality taking into consideration a business model and requirements related to the internal software quality or the quality of use. Modifications and extensions necessary for a software development process can be taken into consideration in a particularly flexible manner.

### PRIORITY STATEMENT

This application is the national phase under 35 U.S.C. § 371 of PCT International Application No. PCT/EP2006/064844 which has an International filing date of Jul. 31, 2006, which designated the United States of America and which claims priority on German Patent Application DE 10 2005 042 126.1 filed Sep. 5, 2005, the entire contents of which are hereby incorporated herein by reference.

### FIELD

At least one embodiment of the invention generally relates to a method and/or a device for automatically evaluating the quality of a software source code.

### BACKGROUND

The improvement of the quality of software code is a continuous aspiration in the development of software, i.e. programs for computers. This applies not only with regard to ensuring the functionality of the software, but also, for example, with regard to its maintainability and portability. It is particularly difficult to achieve an adequately high quality of software when the quantity of source code is large—which is necessary, however, in order to cover the required functionality. In addition, there are often a large number of explicit and implicit informal requirements, with which the developers involved are not familiar to the same extent and which are therefore not adequately taken into account in the development. Furthermore, there is often great time pressure to complete and deliver the software.

To assess the quality of software, quality models have already been developed with which the quality can be assessed in accordance with specified criteria. For example, such a quality model is included in the German industrial standard, DIN, ISO 9126, Information technology—Software product evaluation, Quality characteristics and guidelines for their use, 1991. As well as the quality characteristics, metrics with which the quality of the software is to be measured and specified are also defined in this standard. In addition to this standard, examples of object-oriented metrics are listed in the following: Depth of Inheritance Tree, DIT, Number of Children, NOC, Coupling between Objects, CBO, Weighted Methods per Class, WMC, Response for Class, RFC, Message Passing Coupling, MPC, Lack of Cohesion in Methods, LCOM, etc. These metrics in particular allow characteristics of object-oriented software to be measured on the classes and methods level.

Metrics are indicators for errors contained in the software and frequently only have limited significance. They depend on the technical boundary conditions of the computer systems used, such as memory capacities, response times, throughputs etc., and on implicit requirements of the application domain, e.g. a real-time system. For a reliable assessment of the software quality, it is therefore necessary to have the quality of the software additionally assessed by experts, who manually read through at least parts of the source code in a more or less structured manner. In doing so, potential sources of error are discussed and documented, and possible improvements are proposed, which then preferably lead to the errors in the software being corrected. However, this procedure is becoming increasingly impractical and subject to error due to the rapidly growing quantities of source code, high degree of networking of the systems with their respective application environment, short development times, frequently locally distributed development resources and, not least, the shortage of experts.

### SUMMARY

At least one embodiment of the present invention is directed to enabling a software quality to be automatically evaluated in a simple manner.

According to at least one embodiment of the invention, a method or a device automatically evaluates the quality of a software source code.

As far as the method is concerned, evaluation rules and/or metrics are specified for assessing the quality of the source code. The source code, in particular its quality, is inspected by way of a set of evaluation rules and/or metrics, wherein the set contains at least part of the specified evaluation rules and/or metrics. Subsequently, the set of evaluation rules and/or metrics used for inspecting the source code is checked according to the evaluation of an inspection performed of the source code with respect to at least one specified criterion in order to form an adapted set of evaluation rules and/or metrics, which is different from the first set. In addition, the source code is then inspected by way of the adapted set of evaluation rules and/or metrics.

As far as the device is concerned, evaluation rules and/or metrics are specified for assessing the quality of the source code, and a control device is provided, which is designed so that it enables the source code to be inspected by way of a set of evaluation rules and/or metrics, wherein the set contains at least part of the specified evaluation rules and/or metrics. Furthermore, the control device is designed so that it controls an adaptation of the set of evaluation rules and/or metrics used for inspecting the source code. This takes place in accordance with an evaluation of the inspection performed of the source code with regard to at least one specified criterion. The result is an adapted set of evaluation rules and/or metrics, which is different from the first set.

In addition, the control device enables the source code to be inspected by way of the adapted set of evaluation rules and/or metrics. At the same time, the control device is designed so that it enables the method according to at least one embodiment of the invention to be carried out.

According to an embodiment of the invention, a large number of different evaluation rules and/or metrics are specified as quality indicators with which the quality of different software source codes can be evaluated and sources of errors and problems in the source code can be detected. The formation of the set of evaluation rules and/or metrics enables the inspection of the quality to be individually matched to the purpose and the required functionality of the software. A project-specific set of rules and metrics can therefore be created. In particular, evidence of correctness can also be incorporated into the evaluation rules in as far as it exists for special algorithms.

According to an embodiment of the invention, the development of the software is therefore directed towards the quality objective by the specification and suitable adaptation of the set of evaluation rules and/or metrics and advantageously of limiting values for determining the evaluation rules and/or metrics.

Advantageously, according to an embodiment of the present invention, it is possible to specifically control the evaluation and in particular an improvement in the quality of the source code. The quality is evaluated reliably and repeatedly and, above all, can advantageously be used with large to very large software systems. The safeguarding and control of the internal quality of the software, i.e. the quality during the creation of the source code, the requirements and the comments, and indirectly also the external quality, i.e. the quality of the executable software, can be effectively guaranteed. Due to the high degree of automation, created versions of the source code can be inspected shortly after creation and with limited technical and economic outlay. This provides a rapid, objective decision aid for assessing the quality and in particular also for identifying errors as well as possible improvements.

Advantageously, the adaptation of the set of evaluation rules and/or metrics used for inspecting the source code and the inspection of the source code by way of the adapted set of evaluation rules and/or metrics is repeated until a specified state is achieved for the at least one criterion. The set of evaluation rules and/or metrics is therefore adapted so that the compilation of the evaluation rules and/or metrics in the (adapted) set can be optimized successively and iteratively. This is carried out with regard to the at least one specified criterion, which may be specified by a requirement profile for the creation of the software, for example.

In a further, example embodiment of the invention, when evaluating the inspection performed of the source code, the at least one specified criterion includes a criterion for a degree of automation achieved, a criterion for a coverage achieved of the source code during the inspection and/or a criterion for a coverage achieved of a specified underlying quality model during the inspection. In particular, the quality model can be defined for the software on the basis of a specific business model. Thus, for example, the quality model is derived from the life and the field of use of the software or the product in which the software is used. As a result of these criteria, the set of evaluation rules and/or metrics can be adapted particularly well, in particular to existing resources and objectives such as project objectives, for example.

Particularly preferably, the set of evaluation rules and/or metrics is determined in accordance with a specified quality model with several quality characteristics. Examples of quality characteristics of such a quality model can be maintainability, complexity, reliability, usability, efficiency, transferability, compatibility, productivity, safety, ability to be analyzed and/or effectiveness of the source code. Advantageously, such quality characteristics of the quality model, which can be investigated using static analytical methods, are used for the inspection. In doing so, the individual evaluation rules and/or metrics can advantageously be assigned to specific quality characteristics.

According to an example development of an embodiment of the invention, an overall quality evaluation of the quality of the source code is established by way of individual quality evaluations, which are based on the inspection of the source code by way of the individual evaluation rules and/or metrics of the set used for inspection. The overall quality evaluation and the individual quality evaluations can in each case be represented by reference numbers. Advantageously, this enables the quality to be presented in a clear manner and to be quickly perceived. Furthermore, the respective quality evaluation can easily be used for analyzing problems and for improving the quality of the software.

Particularly preferably, the overall quality evaluation is added to a quality history in which the overall quality evaluations of different versions of the source code are contained. This therefore results in a series of quality evaluations for the different versions, which can be compared with one another. This series of quality evaluations can advantageously be evaluated statistically in order to identify systematic or intermittent sources of error in the form of a trend analysis. In particular, this can relate to specific weaknesses for the project, which are thereby made apparent and enable direct countermeasures to be taken.

In a further, example embodiment of the invention, when the set of evaluation rules and/or metrics is adapted, in particular in the case where new evaluation rules and/or metrics have been added to the set, an overall quality evaluation contained in the quality history for a different source code version is changed depending on the adaptation of the evaluation rules and/or metrics. Advantageously, this contributes to being able to recognize and redress negative trends related thereto at an early stage, right at the creation of the source code. The overall quality evaluations do not necessarily have to be adapted for all versions of the software. Rather, it is sufficient to subject selected versions to an overall assessment depending on the application.

According to a further, example development of an embodiment of the invention, a dynamic test is carried out during the execution of the software in order to check an effect of a correction of the source code carried out as a result of a detected quality defect and/or to prioritize a carrying out of several corrections. In particular, this takes place when peculiarities are present in the quality history for which possible corrections are to be identified by way of detailed analyses. The effect of the possible correction on the code can be analyzed by way of the dynamic test. In addition, when there are several possible corrections, their implementation can be prioritized.

For example, in the case where, in the event of an infringement of a rule, it must be ensured that this rule is complied with in the source code, the dynamic test helps to focus or prioritize the corrections on the most frequently used parts of the source code. In addition, for example in the event of an infringement of a length metric, such as the length metric “number of instructions in a module” for example, the infringement of a complexity metric, such as the complexity metric “number of independent paths”, or the infringement of another context-dependent metric, the dynamic test can detect the specific effects of the respective infringement on the software. In particular, this detection can take place with regard to the size of the loaded source code in the main memory (footprint) and/or the responsiveness of the software (time for the software to respond to an input).

Advantageous embodiments and developments of the invention can be seen in the description with reference to the drawings.

### BRIEF DESCRIPTION OF THE DRAWINGS

The invention is explained in more detail below with reference to example embodiments shown in the drawings. In the drawings:

FIG. 1 shows a schematic representation of an example embodiment of a method according to the invention for automatically evaluating the quality of a software source code; and

FIG. 2 shows a schematic representation of an example embodiment of a device according to the invention for automatically evaluating the quality of a software source code.

### DETAILED DESCRIPTION OF THE EXAMPLE EMBODIMENTS

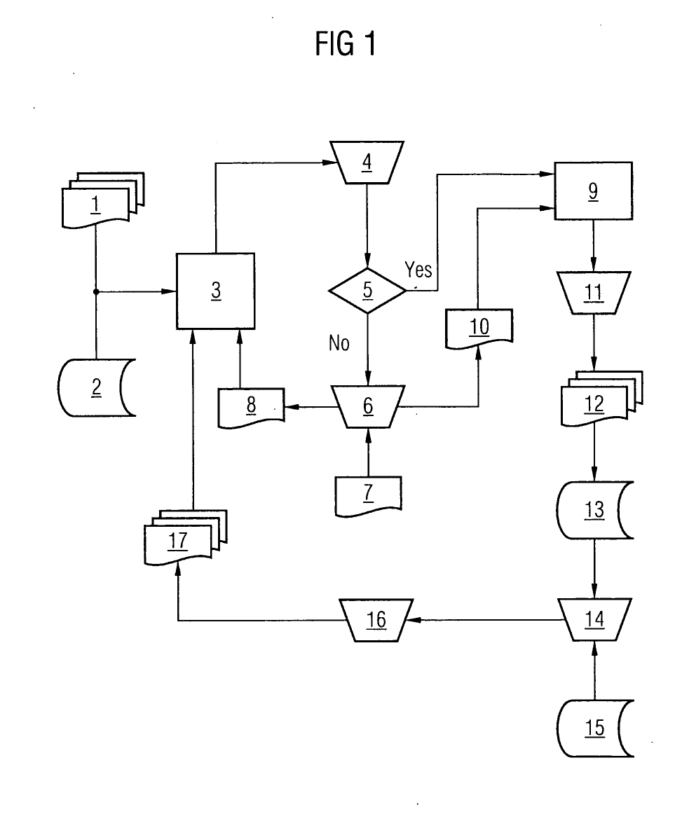

FIG. 1 shows schematically an example embodiment of the method according to the invention for automatically evaluating the quality of a software source code. The starting points for implementing the method are the source code to be evaluated and improved, which is represented in FIG. 1 by the method components with the reference 1. A method component 2 represents a supply of evaluation rules and metrics, which can be used for inspecting the source code.

The evaluation rules are documented, i.e. attributes, which enable or support a selection of the evaluation rules and metrics, are stored with the evaluation rules. Furthermore, the method component 2 represents a specified quality objective, which specifies a required quality that the software must have. The quality objective is based on a specified quality model, to which a large number of quality characteristics are assigned.

The quality characteristics can be checked and assessed by way of the evaluation rules and metrics. Also, errors or sources of problems in the source code, for which the quality characteristics in the source code are not complied with, can be exposed by way of the evaluation rules and metrics. For example, one of the quality characteristics can be the maintainability of the source code.

The maintainability corresponds to an extent to which the software, i.e. the source code, can be changed. These changes include corrections as well as improvements and adaptations to changes in the environment, the requirements and/or the functional specification. The maintainability can be further described by way of other criteria such as simplicity or readability for example.

The simplicity can be described, for example, by a metric CBOR “high coupling due to type use”. This metric CBOR examines the coupling of a class with other classes. A class, which is coupled with many other classes, is inherently complex, i.e. difficult to understand, as all classes used must also be understood, at least from a rudimentary point of view, in order to be able to understand the class itself. This metric CBOR therefore counts the number of different types of attributes, local variables and returned values per class. The method components 1 and 2 thus represent specified conditions for carrying out the method according to an embodiment of the invention.

Based on the specified conditions of source code, quality model, evaluation rules and metrics, the source code is inspected in a process method step 3 by way of an automatic source code inspection and metric tool using a set of the specified evaluation rules and metrics. The part of the specified evaluation rules and metrics used for the inspection is first selected, for example by a software developer or an expert, in accordance with defined, in particular project-specific criteria, so that only part of the specified evaluation rules and metrics are used.

However, it is also possible to use all the specified evaluation rules and metrics for the inspection. In method step 3, individual quality evaluations are defined, which are based on the inspection of the source code by way of the individual evaluation rules and/or metrics of the set used for the inspection. Advantageously, the individual quality evaluations are represented by reference members in each case.

In a method step 4, the results of the inspection method step 3 are checked and evaluated. In doing so, a check is particularly carried out as to which evaluation rules and/or metrics are necessary and applicable depending on the programming language, the application domain and the quality objective. This check can be automated. Checking by an expert is also advantageous as an alternative or in addition.

In a method step 5, a decision is made on the basis of method step 4 whether at least one specified criterion has been fulfilled when evaluating the performed inspection of the source code. In particular, such a criterion can be an achieved degree of automation and/or an achieved coverage of the source code during the inspection. If the at least one criterion is not fulfilled, then the method according to an embodiment of the invention branches to a method step 6.

In this method step 6, the set of evaluation rules and/or metrics is adapted. This takes place depending on the check of the set of evaluation rules and metrics carried out in method step 4 and the check of the fulfillment of the specified criterion carried out in method step 5. The set is adapted specifically for the project so that evaluation rules and metrics, which are context-related and can be checked with the aid of tools and which emanate particularly from the specific application of the software, are added, and previously used evaluation rules and metrics, which are not applicable, are henceforth excluded.

Advantageously, the adaptation can be carried out by specifying further manual evaluation rules, which in particular are based on the experience of a developer or an expert. This is shown in FIG. 1 by a method step 7. The adaptation in method step 6 results in an adapted set of evaluation rules and metrics. This is specified by a method step 8. The method according to an embodiment of the invention then branches once again to method step 3 in which the source code is inspected by way of the adapted set of evaluation rules and metrics and the automatic source code inspection and metric tool. The system cycles through the loop given by method steps 3, 4, 5, 6 and 8 until it is established in method step 5 that the at least one specified criterion is fulfilled.

If this is the case, then the method branches from method step 5 to a method step 9 in which the results of the inspection carried out in method step 3 are combined on the basis of the underlying quality model. Before method step 9 is carried out, new evaluation rules and metrics can be added to the quality model in a method step 10. In addition, the evaluation of the evaluation rules and metrics can be adapted according to the quality objective.

The results are combined in method step 9 in such a way that an overall quality evaluation of the quality of the source code is determined by suitably combining the individual quality evaluations produced in method step 3 for the individual evaluation rules and/or metrics. For this purpose, a mapping function can be defined with which the individual quality evaluations for the individual evaluation rules and/or metrics are weighted and linked together. The overall quality evaluation is likewise represented by a reference number for simplicity.

In a further method step 11, the combination of the evaluation carried out in method step 9 to form the overall quality evaluation can be checked by the expert, in particular based on a plausibility check. A final evaluation of this current version of the software is then available in a method step 12. Advantageously, with this quality evaluation of the current version of the software, the automatically produced individual evaluations of the quality of the software are additionally safeguarded by the expert's check, which guarantees a high reliability of the evaluation.

The final evaluation is added to a quality history in a method step 13. Overall quality evaluations of different versions of the source code are contained in this quality history. The development of the software, and in particular the structure of its functionality, is carried out on a version basis. In this case, the different versions build on one another, and usually a new version improves the functionality, performance and quality of a previous version. As the combined evaluations of the different versions of the software are contained in the quality history, it is possible to compare this series of quality evaluations with one another. This takes place in method step 13.

In addition, in the present exemplary embodiment, added evaluation rules or metrics are used on quality evaluations of older previous versions contained in the quality history in the course of inspecting newer versions. As a result of this, these previous versions are likewise examined using these new rules or metrics so that further individual quality evaluations are produced, which can be used additionally for the assessment of certain trends in the development of the software.

The result of the comparison in method step 13 and the evaluation of the quality history can then be used for specifically improving the software quality. For this purpose, possible corrections are then identified in a method step 14 when peculiarities occur in the quality history. This takes place by analyzing details of the software. For this purpose, dynamic tests can additionally be carried out when the software is running in order to determine the effect of certain corrections on the software quality.

In the dynamic tests, the software is parameterized and made available to the test system in order to be able to determine the specific evaluation reference number for the corrected software. The implementation of several possible corrections can likewise be prioritized in method step 14. When applying rules, which take into account contradictory boundary conditions, a procedure must preferably be chosen which ensures that changes made converge with the general quality objective.

Control of the software quality by identifying and testing the possible corrections can be supported by way of an existing solution library. This is shown in FIG. 1 by the method step 15. In a method step 16, possible corrections that have been identified are then incorporated into the source code in order to improve and expand the software. When the possible corrections have previously been prioritized, these are incorporated according to their priority. An improved new software version is then available in method step 17. This is then fed to the automatic source code inspection and metric tool already described earlier in method step 3. The new software version is then inspected in the manner described above.

Advantageously, as a result of an embodiment of the invention, it is possible to automatically evaluate the current quality of the software source code in a simple manner and with sufficiently accurate and economically justifiable effort. Linking the automated source code inspections and the combination of their results based on the underlying quality model to form a quantified overall conclusion, which can be compared particularly in the specific project, enables the quality to be evaluated and improved in a manner that is particularly effective and easy to see. Project-specific weaknesses can be made apparent and objectively eliminated using quality comparisons, in particular by way of the quality history.

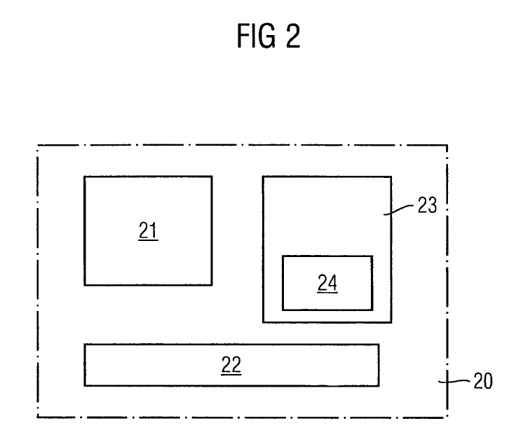

FIG. 2 shows schematically an example embodiment of a device according to the invention for automatically evaluating the quality of a software source code. The method according to an embodiment of the invention for automatically evaluating the quality of a source code as described with reference to FIG. 1 can be carried out with this device.

Here, the device according to an embodiment of the invention is a computer 20. The computer 20 has a monitor 21 and an input device, which in this case is a keyboard 22. In addition, the computer 20 contains a control unit 23, which controls the processes of the computer 20 and in particular the implementation of the method according to an embodiment of the invention.

In particular, the control unit 23 in an embodiment of the invention, contains a processor and a memory in which a suitable program, i.e. software, is stored, which can be executed by the processor in order to implement the method according to an embodiment of the invention. The control unit 23 contains a software memory 24 in which the source code of the software, the quality of which is to be inspected, is stored. The control unit 23 therefore accesses the memory 24 while the source code is being evaluated and inspected.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for evaluating quality of a software source code in which at least one of evaluation rules and metrics for assessing equality of the source code specified, the method comprising:
inspecting the source code by way of a set of at least one of evaluation rules and metrics, wherein the set contains at least part of the specified at least one of evaluation rules and metrics;
adapting the set of at least one of evaluation rules and metrics used for inspecting the source code, according to an evaluation of the inspecting of the source code with respect to at least one specified criterion, to form an adapted set of at least one of evaluation rules and metrics, different from the set; and
inspecting the source code, for quality evaluation of the source code, by way of the adapted set of at least one of evaluation rules and metrics.

2. The method as claimed in claim 1, wherein the adapting of the set of at least one of evaluation rules and metrics used for inspecting the source code and the inspecting of the source code by way of the adapted set of at least one of evaluation rules and metrics is repeated until a specified state is achieved for the at least one criterion.

3. The method as claimed in claim 1, wherein, when evaluating the performed inspecting of the source code, the at least one specified criterion includes at least one of a criterion of an achieved degree of automation, a criterion of an achieved coverage of the source code during the inspecting and a criterion of an achieved coverage of a specified underlying quality model during the inspecting.

4. The method as claimed in claim 1, wherein the set of at least one of evaluation rules and metrics is determined in accordance with a specified quality model with several quality characteristics.

5. The method as claimed in claim 1, wherein an overall quality evaluation of the quality of the source code is established by way of individual quality evaluations, based on the inspection of the source code by way of at least one of individual evaluation rules and metrics of the set used for inspection.

6. The method as claimed in claim 5, wherein the overall quality evaluation is added to a quality history in which the overall quality evaluations of different versions of the source code are contained.

7. The method as claimed in claim 6, wherein, when the set of at least one of evaluation rules and metrics is adapted, an overall quality evaluation contained in the quality history for a different source code version is changed depending on the adaptation of the at least one of evaluation rules and metrics.

8. The method as claimed in claim 1, wherein a dynamic test is carried out during the execution of the software at least one of to check an effect of a correction of the source code carried out as a result of a detected quality defect and to prioritize a carrying out of several corrections.

9. Device for evaluating quality of a software source code, wherein at least one of evaluation rules and metrics for assessing the quality of the source code are specified, the device comprising:
a control device, designed to enable
inspection of the source code by way of a set of at least one of evaluation rules and metrics, wherein the set contains at least part of the specified at least one of evaluation rules an metrics,
adaptation of the set of at least one of evaluation rules and metrics used for inspecting the source code according to an evaluation of the performed inspection of the source code with respect to at least one specified criterion to form an adapted set of at least one of evaluation rules and metrics, different from the set, and
inspection of the source code for quality evaluation of the source code, by way of the adapted set of at least one of evaluation rules and metrics.

10. The method as claimed in claim 2, wherein, when evaluating the performed inspecting of the source code, the at least one specified criterion includes at least one of a criterion of an achieved degree of automation, a criterion of an achieved coverage of the source code during the inspecting and a criterion of an achieved coverage of a specified underlying quality model during the inspecting.

11. The method as claimed in claim 2, wherein the set of at least one of evaluation rules and metrics is determined in accordance with a specified quality model with several quality characteristics.

12. The method as claimed in claim 3, wherein the set of at least one of evaluation rules and metrics is determined in accordance with a specified quality model with several quality characteristics.

13. The method as claimed in claim 10, wherein the set of at least one of evaluation rules and metrics is determined in accordance with a specified quality model with several quality characteristics.

14. The method as claimed in claim 7, wherein new at least one of evaluation rules and metrics are added to the set.

15. A device for evaluating quality of a software source code in which at least one of evaluation rules and metrics for assessing quality of the source code is specified, the method comprising:
means for inspecting the source code by way of a set of at least one of evaluation rules and metrics, wherein the set contains at least part of the specified at least one of evaluation rules and metrics;
means for adapting the set of at least one of evaluation rules and metrics used for inspecting the source code, according to an evaluation of the inspecting of the source code with respect to at least one specified criterion, to form an adapted set of at least one of evaluation rules and metrics, different from the set; and
means for inspecting the source code, for quality evaluation of the source code, by way of the adapted set of at least one of evaluation rules and metrics.

16. A computer readable medium including program segments for, when executed on a computer device of an image processing system, causing the computer device to implement the method of claim 1.
